(19) United States
(12) Patent Application Publication
(10) Pub. No.: US 2003/0233242 A1
(43) Pub. Date: Dec. 18, 2003

(54) Method and system for auditing academic credit for employment and training

(76) Inventor: Denise A. Wenger, Pewaukee, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/170,275

(22) Filed: Jun. 12, 2002

(51) Int. Cl. G06F 17/60

(52) U.S. Cl. 705/1

(57) ABSTRACT

Academic Credit for Employment and Training (or “ACET”) Auditor is a method and system provides unique information, credit auditing and record keeping services to assist veterans and other individuals with opportunity identification and credit analysis during career planning. The method and system extends the hierarchy for credit-based programs so that employment experience and training is valued in terms of “academic credit.” The method and system audits personal transcripts and employment records against credits or program requirements and provides a report on the advanced standing that veterans or other individuals can achieve at particular institutions of high education or with licensure programs based on their military, employment and training records.

### FIELD OF THE INVENTION

This invention relates generally to methods and systems for acquiring, storing, processing and retrieving data. More specifically, it relates to a method and system for supplying employment training and analysis services that are designed to assist in reintegrating eligible veterans and other unemployed individuals into meaningful employment within the labor force.

### BACKGROUND OF THE INVENTION

Persons entering the job market traditionally rely upon experience and scholastic achievements to convince a potential employer that he or she are qualified to perform a specific job or occupation. Veterans leaving the military are confronted with similar challenges, but also encounter the added problem of accounting for training and experience that the individual may have received during his or her term of military service or other employment. Historically, military veterans in career transition who seek admission to institutions of higher learning have not received many or any credits for their military training and/or employment experiences. Often the awarding of credits has been less than equitable and credit award information arrives so late in the planning process that it cannot be used by program applicants when considering employment, career or training options. In the experience of this inventor, and as it reflects on veterans or other individuals, there clearly is a gap in the work force development infrastructure as it relates to employment and training assessment, credit auditing and development of employment and education planning systems for veterans. There currently is no comprehensive and consistent method for analyzing the training and education that veterans have obtained.

In prior art, the definition of “academic credit” has been restricted to credit-based college or technical college programs. Also in prior art, a veteran had to contact schools individually and request a review of a transcript to estimate possible credit transfer awards. Research on prior art in the field of academic credit awards for experience and training, conducted recently by this inventor, indicates that registrars spend an average of four to twelve hours reviewing each transcript for a veteran applicant. Many transcripts undergo additional review by department chairpersons or staff before credit transfer awards are made. Transcript analysis delays generally mean that an applicant does not have access to comparative information on possible credit awards at different institutions or programs during the opportunity identification phase of career planning. In some institutions, the transcript analysis process takes so much staff time that the registrar and/or program chair will not review an applicant's transcript for possible transfer credit until the applicant has enrolled in the program. Similar review processes are used at training institutions elsewhere. When completed, records of awards are attached to the individual transcript and filed, not recorded in an electronic database. Each applicant is treated individually, and there is little equity in the awarding of transfer credits, even when applicants have completed identical courses during military service.

What is needed is a method and system that provides unique information, credit auditing and record keeping services to assist veterans and other individuals with opportunity identification and credit analysis during career planning. Such a method and system would extend the hierarchy for credit-based programs so that employment experience and training would be valued in terms of “academic credit.” This re-valuing of employment and training means that military courses and employment for specific Military Occupational Specialists (MOS's) could be re-valued in terms of program and licensure requirements, and credits can provide advanced standing for schooling or satisfy certification requirements for licensure for veterans and others. This transformation of the state of employment and training in terms of “academic credits” has the potential for saving millions of dollars a year in tuition reimbursement costs for federal and state veterans' agencies, school districts and corporations who support tuition reimbursement programs for veterans and others.

What is also needed is a method and system that stimulates the development of new, effective service delivery systems that address several complex problems facing eligible veterans and others, including equity in the awarding of credit for military and other employment and training. Such a method and system would advance strategic goals of the United States Veterans Administration by promoting increased use of the Montgomery G.I. Bill and work as an advocate to increase academic awards for military and other training and experience. Such a method and system would also decrease time for processing applications and claims and it would assist with employability training, shift responsibility from employment skill development from the state agencies to the individuals, and supply ongoing support that veterans and others can access throughout their careers. Additionally, such a method and system would be designed to serve veterans and others, employment and training personnel, school registrars and education fund administrators on a virtually full time basis. The method and system of the present invention has obtained these objects.

### SUMMARY OF THE INVENTION

The method and system of the present invention is a unique internet-based planning and evaluation tool known as the Academic Credit for Employment and Training (or “ACET”) Auditor. The ACET Auditor provides unique information, credit auditing and record keeping services to assist veterans and others with opportunity identification and analysis during career planning. The method and system audits personal transcripts and employment records against credits or program requirement and provides a report on the advanced standing that veterans can achieve at particular institutions based on their military, employment and training records. This method and system makes it possible for veterans and others to compare any number of career options, including the time/cost of training, as they develop a comprehensive employment development plan. It allows them to engage in this auditing process at many times in their careers. The audit report issued by the system details requirements and costs involved with pursuing specific careers at learning institutions, schools, programs and other training programs approved by state educational boards under of the United States Code. It details credit awards that are possible in many fields of study and it supplies core training for veterans. The system focuses on a variety of high need fields such as teaching, engineering and nursing, and encourages veterans to engage in opportunity analysis as they map their training and employment plans. Personal transcript analysis and credit auditing services provided by the system deliver information on possible credit awards for advanced standing status in academic programs and certification programs at local and regional institutions of higher education. Record keeping systems provide a platform for mapping and recording life-long education and employment plans and achievements for each veteran or other individual who chooses to participate in and take advantage of this system. By virtue of this program, ACET Auditor provides training to develop job skills and enhance job readiness. It offers links to training and job listings in expanding industries. It supplies links to vital information on placement and training options during opportunity identification stages of employment planning and offers ongoing access to personal employment record-keeping systems and supplies online systems for post-placement follow-up.

The benefits of the method and system of the present invention are clear. For individual users such as veterans, ACET Auditor supplies personal audits of the credit and tuition cost value of his/her record of employment or experience and training relative to credit requirements of training or certification programs at public and private institutions of higher education (or “IHEs”) or other training institutions. ACET Auditor offers real-time, online transcript record keeping and analysis services for credits posted by the user from transcript sources such as a military DD214 and other military-linked IHEs. It assembles information in a secure database and uses it to produce a personal audit statement that results from a comparison of the user's record to the requirements for a program at a selected school. The analysis includes a calculation of the credit value of the user's employment and training record and a calculation of the tuition cost value of possible credit awards, based on current in-state or out-of-state tuition rates at the selected school. It supplies this service on a 24-7 basis via the internet, so it can be used for opportunity identification and decision making during career transition by veterans and others entering the labor force.

For registrars and admissions personnel at IHEs, ACET Auditor provides online research links that aid credit and transcript evaluation and provide access to new databases, created for the system by partner schools. New databases, created by the ACET Auditor, document and report credit equivalencies established between specific lists of courses, including military courses listed by ACEnet (the online listing provided by the American Council on Education) and courses at partner schools. Online access to the Database of Equivalencies provides novel services to the prior art for the environment in which registrars and credit evaluators make credit decisions. While transfer credits have been established as prior art, the establishment of a Database of Equivalencies which translates a variety of employment and training programs into possible credits for use by evaluators and the production feature which gives registrars access to the Database of Equivalencies at other partner institutions is novel and effects the environment in which the program operates.

For employment and training, licensing agencies, and licensees, ACET Auditor provides online credential record-keeping services for individual users. The system records employment and training plans required by the Department of Labor, Employment and Training. For licensing agencies and licensees, ACET Auditor provides online license auditing services which evaluate credit awards and/or portfolio-based awards against qualifications or standards for licensing published by each state for a variety of licenses, including teaching licenses.

For administrators of education trust funds such as the G.I Bill, ACET Auditor provides advocacy services for applicants to training programs, builds equity into transfer credit award systems, and increases the number of possible awards available to veterans at partner IHEs. Increases in the number of academic credits awarded for employment and training translate into increasing tuition dollar savings for national and state education trust funds administrators.

ACET Auditor affects the prior art for different fields:

In the field of employment and training, it supplies basic employment training skills and training in development of portfolio entries that transform the perceptions of users on the value of employment records, record keeping, and career planning. It shifts responsibility (locus of control) for employment skill development from employment agency to the individual.

In the field of academic credit evaluation, the ACET Auditor system effects several changes. It reduces time required of registrars and school admissions personnel for processing applications. It connects users to online services for issuing tuition reimbursement claims.

In the field of employment and training and certification for licensure, it transforms employment skill training from a staff-intensive job current service to an online 24/7 user-initiated skill development service. It provides ongoing transcript development support and record access for individuals, supporting current and ongoing service needs. It provides online record keeping and auditing that users can access 24/7 throughout their careers.

In the field of certification for licensure, it transforms the concept of “academic credit,” so that the prior art definition is changed to include significant employment experience and training that has an assigned “academic credit” value. It reduces the time required for transcript analysis and (transfer) credit awards and increases enrollments in programs that offer equivalency credits.

In the field of certification for licensure, it transforms auditing services to assess user qualifications for standards-based licensures in teaching and other professions. These effects are measured by tracking system tools included in the program.

The foregoing and other features of the method and system of the present invention will become apparent from the detailed description that follows.

### BRIEF DESCRIPTION OF THE DRAWINGS

FIG. 1 is a schematic drawing illustrating the production overview for the method and system of the present invention.

FIG. 2 is a schematic drawing illustrating the workflow process overview for the method and system of the present invention.

### DETAILED DESCRIPTION

ACET Auditor is a novel computer-based method and system that provides services to the fields of employment and training, academic credit evaluation, and certification for licensure. The system and subsystems provide services to fill gaps in the infrastructure for these fields. It is designed to serve the special needs of veterans and others, employment and training personnel, registrars an education fund administrators on a 24/7 basis.

To support employment and training needs, the method and system of the present invention offers online transcript development and career development services and provides links to resources to support individual users during opportunity identification and analysis stages of career planning. It functions as an online credit auditor service for individuals, veterans, and others. Its audit function supplies novel services that address several complex problems for individuals in career transition, including equity in the awarding of credit for military employment and training and timeliness of transcript evaluation for credit awards. It performs transcript analysis using individual transcript records to determine possible transfer credit awards available from programs or certification/licensure programs offered by partner schools. It links individual users to valuable research resources that supply documentation for military records, courses listed in ACEnet (the American College of Education online listing of courses offered by all branches of the military that includes credit award recommendations), and partner schools. It also links them to valuable online training provided within the ACET Auditor system. It produces reports that profile credit awards and their cost impact for the individual.

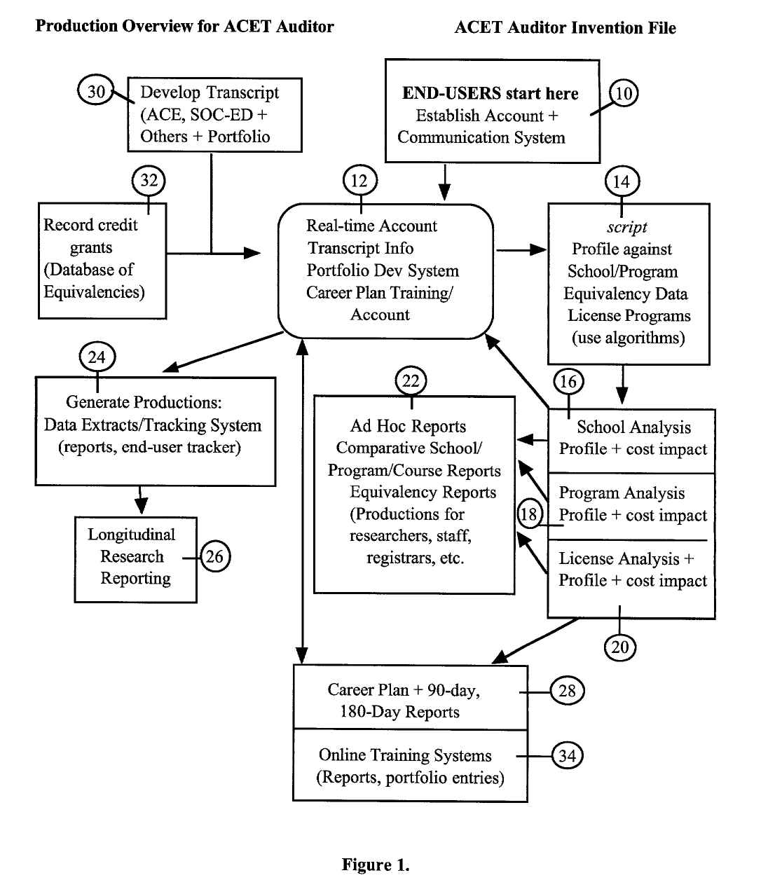

ACET Auditor supplies basic employment skills training for unemployed workers. As shown in FIG. 1, the method and system of the present invention maintains real-time accounts 12 for individuals that include transcript information, portfolio entries, and career plans, including 90-day and 180-day employment reports 28. It supplies a unique Portfolio Development System 12 and Online Training Systems 34 that deliver employment skill training and a scaffolded set of training experiences designed to develop Portfolio entries that users can submit as evidence of employment and training equivalency for program or certification requirements 22 at partner schools. It also supplies training for writing and maintaining an individualized Career Plan for Employment and Training 12. The real-time account 12 system links users to Online Training Systems 34 that provide training services for the Portfolio Development System, Career Plan Training and Employment Skills Training. These training systems serve development functions for the individual account holder 10.

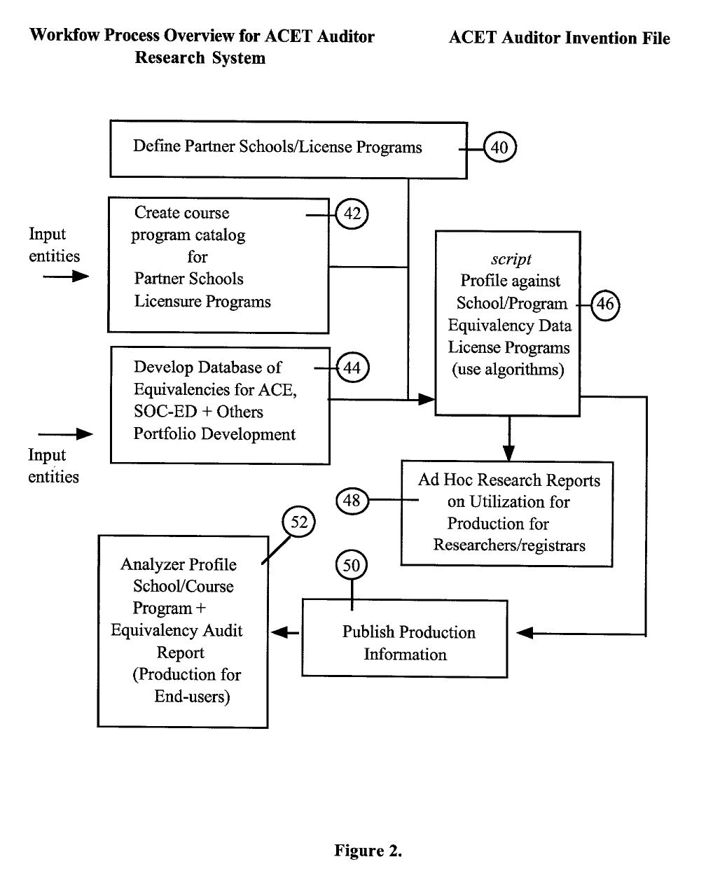

For academic credit evaluation, ACET Auditor functions as an aide for transcript analysis and evaluation 22, serving registrars and school admissions personnel and saving them an estimated two to ten hours per applicant. Its functions work as an online advocate and online record keeping system which promotes equity in the awarding of academic credit for prior employment experience and training. Through a novel Research System as shown in FIG. 2, ACET Auditor provides registrars with records of equivalency awards available at all partner schools 40. Training subsystems designed for registrars and other users of the research system include protocols for entering historical equivalencies and for developing future equivalency awards based on courses from accredited programs, employment experience and prior training. In addition, the research system provides links to ACEnet and other program lists. Registrars can access these lists during transcript analysis and the equivalency development process. In special report functions, the system produces data extracts and tracking data from the research system 24 and other systems for longitudinal research 26, and it calculates potential and actual tuition savings for federal/state agencies and companies which provide tuition reimbursements to veterans or employees.

In the field of certification for licensure, the ACET Auditor streamlines certification and licensure processes. It establishes equivalencies between employment experience and training, such as military teaching, and courses required for certification. It serves veterans and other individuals who seek transition to careers in professions for which they have prior employment and training, helping them establish the value of employment-related service and training in meeting certification requirements and state standards.

In general, the ACET Auditor method and system of the present invention performs the following major functions: Profiling for Schools Program (Degree, Programs, License Program); Account and Transcript Management; Transcript Analysis; Cost Impact; Credit Tracking and Career Planning. A description of each of these functions is as follows:

Profiling for Schools (Degree, Programs, Licensure) Program. Referring again to FIG. 2, wherein partner schools participating in the ACET Auditor program are defined 40, their course program catalogs are created 42 and a Database of Equivalencies is developed 44, this function compares 46 colleges without regard to a specific candidate and presents requirements for degrees at the school, for a specific program of study, and/or for a specific licensure program. For example, a profile might include the BS degree in the College of Business, Industry, Life Science, and Agriculture at XYZ University. It could profile a specific program of study, i.e. biology, in that college/university. It could also profile the state standards or college course requirements for a specific licensure for teaching.

Account and Transcript Management. This function allows end-users to establish and maintain an account 10 on the system. See FIG. 1. Each account includes basic demographic information about the person, details of their transcript 30 (including ACE, SOC-ED, MOS-required courses and other records of credit awards 32 from sources such as SAT/ACT or a Portfolio or test-out process).

Transcript Analysis. Referring again to FIG. 1, this function provides the individual user with an analysis 14 for a transcript in the context of a selected school 16 (School Analysis), a program 18 (Program Analysis), or a specific license 20 (License Analysis). There are multiple options for analysis available in this system. First, a user can examine possible general credit without regard to a program of study 16 (School Analysis). Second, the user can identify a program 18 and see what equivalency credit may be applied to that program, as opposed to general credit (Program Analysis). Third, the user can identify a licensure program 20 and see what equivalency credit may be applied to that program. For the credit granted, the system identifies how much credit would be applied against a total degree requirement, as opposed to credit granted but not applied to the loan required for graduation (defrayed credits for courses which will not be required are noted.)

Cost Impact. Given the Account and Transcript Management and Transcript Analysis (as described above), this function estimates the cost 16 to the student (based on current tuition rates) of completing a degree at each selected college (one college at a time) for which an audit report is run.

Credit Tracking. For an individual user, this function tracks what kind of credit was granted or could be granted by a partner school 32 over time. Credit could be awarded for military courses or experience through ACE courses, CLEP tests, SAT/ACT tests, or Portfolio reviews. A Database of Equivalencies 32, 44 is created (date of each entry is noted) and maintained for each partner school. No such database is known to exist at a regional or national level.

Career Planning System. This function manages the Career Planning system which includes a Career Plan 28 plus 90-day and 180-day Reports for employment. It is linked to training subsystems 34 and tracks credits achieved through training or Portfolio processes 24. Subsystems include Portfolio Development Process, Career Plan Training and other online training systems 34.

Viewed from an information basis, the ACET Auditor method and system manages several classes of information in various databases. See FIG. 2. These databases are described as follows:

Curriculum/Licensure Catalog. This database 42 includes a description of college programs in terms of different course areas or departments (Biology, Mathematics, English, etc.) and the number of credits required for each program. This collection 42 includes licensure programs. Information is entered into this database 42 through the Research System by the registrar or admissions personnel of each Partner School/License Program 40 (subsystems 42 and 44).

End-user Information. This database 12 includes information supplied by the end-user, including demographic information and security (User ID and password) information. Each user supplies his or her confidential password. The End-user Information can be accessed only by that end-user.

Transcript Subsystem. This 30 system supports the recording of ACE and other transcripts for users. Transcript information includes two classes of information: title of the transcript entry (course or source title) and a record of what academic credits apply. The transcript entry or title and credits could be recorded from any number of sources, including military training systems and others.

Course Equivalencies Subsystem. This subsystem 44 includes information regarding equivalencies that have been formalized between the ACE and other program courses and college courses from partner schools. Information is entered into this database through the Research system by the registrar or admissions personnel 40.

In order to support auditing directions for School Analysis, Program and License Analysis, the selection and arrangement of data supplied from public and college databases (for college and program requirements) required novel database designs. In the field, colleges differ in the relations they establish between objects in the class called “requirements.” The arrangement of data to support the variety of use-cases (and use-cases, or “containers” describe the use-scenarios of an object) represented in college catalogs requires formulation of an appropriate internal design for the information containers.

The container object for collections of courses are designed so that all requirements associated with a program of study are represented in the container. Each container houses a collection of one or more courses. The container has a credit value which is equal to the number of credits required from a set of courses. This arrangement permits the following type of requirement to be represented in the container. “Students must complete 4 credits from the following four (biology) courses: 09-244, 09-354, 09-364 or 09-414.” In this example, we have one container record with credit=4.

All courses must belong to a container in order to be associated with a program of study. Thus, there are many containers with a single course, but there also are containers with 80 courses. This container design represents a novel solution that is required for consistent processing of a transcript to determine equivalency credit to be granted. It represents one of a set of containers whose internal arrangement supports School Analysis Program and License Analysis and the Database of Equivalencies which is claimed as novel.

The invention of a container design that could be used for all colleges/schools/training programs that are anticipated as data sources results in novel arrangements of data for ACET Auditor databases and results in the design of the new database called the Database of Equivalencies.

The container design also requires development of novel online subsystem mechanisms (for ongoing information-database development) by which registrars can input new data into containers for courses, program/licensure requirements, and equivalency containers, on an ongoing basis and periodic basis. These mechanisms are not necessarily unique, but they function to direct new information to the correct location and support the novel arrangement provided by the container design in a set of containers. They are sub-system extensions of the novel arrangement of data required for proper processing of information and are claimed as novel inventions.

Note that it is the container design, arrangement of the data within containers, the relative use of the containers during auditing services (using scripted algorithms) and the set of containers, and not the content of the container(s) which must change periodically to reflect changes in requirements or course offerings or programs offered by a partner school.

The tables and containers required to support auditing services include:

1. TblACETSchool

A simple directory of partner schools who are participants in the ACET Auditor program. Includes: School ID, School name, TIS institution ID (State TIS number), PIN (school's research system access code number), Cost WI (tuition in state), Cost MN (tuition cost with MN compact), Cost Nonresident, Disclaimer (Credit disclaimer school authors for end of report), last Update Date.

2. TblACETProgram

A catalog of programs offered at a partner school, listing major or program of study. Includes: Program ID, School ID, Department ID, Program Type, Program Number, Program Title, Total Credits, General Credit, Major Credits, Concentration Credits, Elective Credits, Minor Credits, Comments (For partner school use only, not visible to End-users), Creation Date, Last Update Date.

3. TblACETAce

Catalog of all ACEnet courses, all branches of service, derived from ACEnet (online catalog). Includes: ACE number, ACE title, ACE hyperlink, Comments.

4. TblACETCourse

Courses keyed to the partner school which offers them. Includes: Course ID, School ID, Department ID, Course No., Course Title, Credit, Comments, Creation Date, Last Update Date.

5. TblACETCourseContainer

Container object for collections of one or more courses. The container has credit value, which is the credits that must be fulfilled from a set of courses. NOTE: All courses must belong to a container in order to be associated with a program of study. This allows for a consistent processing of a transcript to determine equivalency credit to be granted. Includes: Container ID, Program ID, Container credit, Creation Date.

6. TblACET Course ContainerXref

Cross reference table that links courses to container instances in a many-go-one fashion. Includes: Container ID, Program ID, Container Credit.

7. TblACET Equivalencies (Database of Equivalencies)

Equivalencies for a course in the context of a school. Includes: School ID, ACE No, Course ID, Course No, Credit, Defray, Comments (Developer or ACET Partner comments), Drop flag (flag directing that the equivalency should be dropped from the database upon implementing new revisions), Creation Date, Last Update Date.

The tables and containers required to support production services include:

8. TBLACET AnalyzerLog

Maintains a log of analyses run by end users. Includes: User ID, School ID, Program ID, All Credit (overall amount of credit from general, in-program and out-of-program credit), Program Credit, Creation Date.

9. TBLACET AccessLog

Maintains a log of access by end users. Includes: User ID, Session ID, Personal Modification (flag indicating whether they modified personal info), Transcript Modification (flag indicating whether they modified transcript info during the session), Creation date.

10. TblACET School

Simple director of all schools participating in the ACME program. Includes: School ID, School name, TIS institution ID (State TIS number), PIN (school's research system access code number), Cost WI (Tuition in state), Cost MN (tuition cost with MN compact), Cost Nonresident, Disclaimer (Credit disclaimer school authors for end of report), Last Update Date.

11. TblACETAce

Catalog of all ACE courses, all branches of service derived from ACEnet (online catalog). Includes: ACE number, ACE title, ACE hyperlink, Comment.

12. TblACETCourseContainerXref

Cross reference table that links courses to container instances in a many-go-one fashion. Includes: Container ID, Program ID, Container Credit.

13. TblACETCourseContainer

Container object for collections of one or more courses. The container has credit value, which is the credits that must be fulfilled from a set of courses. NOTE: All courses must belong to a container in order to be associated with a program of study. This allows for a consistent processing of a transcript to determine equivalency credit to be granted. Includes: Container ID, Program ID, Container Credit, Creation Date.

14. TblACETCourse

Catalog of all college courses. Includes: Course ID, School ID, Department ID, Course No, Course Title, Credit, Comments, Creation Date, Last Update Date.

15. TblACETEquivalencies

Defines credit relationship between college courses and ACE (or other source) courses. Includes: School ID, ACE No., Course ID, Course No., Credit, Defray, Comments (Developer or ACET Partner comments), Drop flag (flag directing that the equivalency should be dropped from the database upon implementing new revisions), Creation Date, Last Update Date.

User Tables, relating to transcript development, include:

16. TblACETUser

Includes: User Id, First name, MI, Last Name, DOB, Gender, Street 1, Street 2, City, State, Zip5, Phone, Email, Branch, Status (active, retired, veteran), Pay Grade, PMSI (Primary Military Skills Indicator/Military Occupational Status), YAS (years of active service), HD (honorable discharge), Rdate (Retirement date), Grad Degree, Bac Degree, Asso Degree, TTO (Foreign key to tblTroops_Teachers), Teach Cert, Teach State, Teach date, Teach subjects, Teach Prog, Teach Prog Insti, Teach Prog City, Teach Prog State, Teach Prog Subjects, Teach Prog Date, Teach prog Edate (exit date), Comments, Creation Date, Last Update Date.

17. TblACET Accounts

Log On information for account holders. Includes: User ID, UID, PW (password).

18. TblACETTranscript

Transcript record for account holders (one record per user account). Includes: User ID, ACE credit, ACE date, Portfolio credit, Portfolio date, CLEP date, Dantes credit, Dantes date, AP Credit, AP Date, ACT Credit, ACT Date, Test-out Credit, Test-out Date, RetroFL (Retroactive foreign language), Retro Credit, Retro Date, Other Credit, Other Date, School ID, Program ID.

19. TblACETTransACEXref

Manages the collection of ACE courses tied to each user's transcript. Includes: User ID, ACE No.

20. TblACETProgram

Lists the programs and major available at the partner schools. Includes: Program ID, School ID, Department ID, Program Type, Program Number, Program Title, Total Credits, General Credit, Major Credits, Concentration Credits, Elective Credits, Minor Credits, Comments (For partner school use only, not visible to End-users), Creation Date, Last Update Date.

The method and system of the present invention includes a number of functional systems that are required to manage research information in the development environment and transcript information, profiling and reporting in the production environment. The research and development environment and the production environment are each described as follows:

Managing Research Information in the Development Environment. In the method and system of the present invention, program managers manage and maintain information about schools, courses and equivalencies. When possible, updates to these databases are completed electronically. Data is obtained 42, 44 from partner schools or the university system 40. Partner schools access these files remotely through the Research system. They update their information several times a year and verify accuracy of program, course, and equivalency databases at least once a year on a schedule included in the Registrar's Manual. In application, program managers and partner schools access the research database using a standard web browser. Access to research data is managed using an accounting system maintained in the database and validated through server side script. Registrars access the Databank of Equivalencies and other research development systems using an assigned PIN. Equivalency credits for courses at each school are entered on a course-by-course basis. Development systems provide online support for entering and editing courses, entering and editing programs, school information (college statements, disclaimers and per credit cost/tuition rates), building a Database of Equivalencies, specifying whether or not credits will defray credits required for a specific program (if the awarded credit defrays, the registrar checks defray in the support system). All programmatic manipulation of research data is done using ASP scripting. Equivalency report functions, available to registrars and users of the Database of Equivalencies in the Research System, relate (input) courses from one program/school to courses from an ACET Auditor partner school. Reports on Database of Equivalency entries can be grouped by equivalent course number or by partner school courses. Registrars are able to draw reports for their own institution and for any other institution and print those reports from the database 22, 48. Data Extracts/Tracking System 24 reports track the movement of end-users through the system (for longitudinal research reporting 26). It also tracks 24 user perceptions used to measure effectiveness of the system in changing the user's locus of control for accountability purposes.

Maintaining Transcript Information. Individuals and military personnel maintain personal transcript information 10, 12 in the ACET Auditor system. They can modify information in real-time, as additional courses are taken, employment changes, or new information becomes available. In application, the system permits individual users to establish accounts 10 for themselves. Accounts are accessed through a combination user ID and password, as specified by the user when the account is established. Users record 32 their transcript history, including military courses completed, by course number and title. ACE course identification utilizes a “fixed choice” mechanism which ensures that only valid course numbers are identified within the transcript. The system provides a link to ACE Net Military Guide Online (http://www.ACEnet.edu) which helps the user correctly identify a completed ACE course. All search capabilities are limited to the databases for which links are provided. A variety of reports are available, including a transcript information report 12 (for the account holder); transcript information for one or more account holders (for ACET Auditor staff or personnel); reports of types of credit granted for collections of users (for ACET Auditor staff or personnel); and various reports and data extracts on system utilization 24 (for longitudinal research reporting 26).

With particular attention to School Profiles, account holders can compare 14 their transcript records to sets of equivalencies at each school in the system to determine what academic credits are possible, based on their transcript records. In application, users select the school they want to profile their transcript against. They have three options for transcript analysis. They can elect to have their transcript profiled 14 against School/Program or Equivalency Data or License Programs. The analysis provides a profile which details (1) overall credits required to complete the program, (2) credits that may be granted due to the ACE (or other) transcript entries, and (3) estimated cost needed to complete the degree or licensure program. If the user selects a major field of study for a transcript analysis, the program breaks credit down into three categories: general degree credit awards, credits toward the major, and elective/concentration credit granted. The following processing algorithms apply to transcript analysis:

(A) For School Analysis Profile+Cost Impact Report 16:

1. For the current user and elected school, compare transcript ACE courses to defined equivalencies to derive granted credit.

2. Based on granted credit, derive estimated cost impact.

3. Print Report.

4. Print equivalency information.

5. Print cost impact information.

(B) For Program and License Analysis 18, 20:

1. For the user and selected school and program/license compare transcript courses (from ACE and other sources) to defined equivalencies to derive granted credit in the general area for required courses.

2. Repeat above for required course containers, eliminating duplicates previously allocated.

3. Repeat above for required courses at a specified level.

4. Repeat above for any defined concentration courses.

5. Repeat above for any other equivalencies that have not been allocated.

6. Print Report.

7. Print equivalency information.

8. Print cost impact information.

In the system and method of the present invention, various End-user Reports 22 may be generated. One report, for ACE courses and matching college courses for which credit is given at candidate selected schools, comes in two versions:

(A) Report for School Analysis 16:

1. Summary of user account and transcript information (ACE only)

2. Selected School

3. General Credit Granted

4. Cost impact statement

(B) Report for School Program and License Analysis 18, 20:

1. Summary of account holder and transcript information (ACE only)

2. Selected School

3. Description of program requirements

4. Program-related credit granted

5. Remaining general credit granted

6. Cost impact statement

Other End-user Reports include estimated cost savings of credit awards and description of course requirements for program of study, based on degree and major, for a selected school 16. Administrative and research reports 50, 52 may also be generated including utilization reports using Web Trends technology and scheduled for Longitudinal Research Reporting 24, 26.

The novel Portfolio Development System 12, 44 provides training that transforms mental processes in users and changes their prior art concept of the value of employment experience and training to future opportunities for schooling and employment. The system engages users in training exercises which teach users to value their prior experience and training in the context of a program or employment opportunity before them.

The product of the Portfolio Development System is one or more portfolio entries or reports that describe equivalent work and can be used in the application process for admissions to school programs (at ACET partner schools or others) or employment.

The mental transformations which occur within the individual are accomplished through a series of cognitive steps-of-process designed for the ACET Auditor invention. The steps of process have been tested by this inventor and found to be effective at the 0.98 level of significance when used with over 200 teachers. The steps-of-process designed for ACET Auditor represent scaffolded instruction designed to teach abstraction skills and higher-order thinking and decision-making skills needed to produce portfolio entries that serve the user in the application process.

For applicants for employment, the Portfolio Development System 12, 44 includes online templates for resumes and follow-up activities at 90-days and 180-days after employment 28. Online reports from these activities are designed to supply Department of Labor (DOL) Job Service staff with information they need for 90-day and 180-day reports required by the DOL. For applicants for schooling, the Portfolio Development System includes online templates (Credit Award Report forms) that registrars use to report equivalency awards secured (bases on an ACET Auditor portfolio entry submitted by an End-user to a partner school). Credit Award Report forms are filed in the ACET Auditor system by the registrar awarding the credit. The record of Credit award is entered into the End-user's file, and the complete file is retained in the Portfolio Development System 12, 44. All Portfolio Development System entries are treated as records in the system. They are retained in the End-users file and can be accessed by the account holder throughout their training, employment or career.

Information Requirements for implementation of the ACET Auditor method and system of the present invention are described as follows:

(A) End-user information 10:

1. Account information (user ID, password)

2. Demographic information

3. Service information/teaching record

4. Transcript information (ACE and other)

5. Credit granted (for Ace, CLEP, Portfolio, etc.)

(B) School/Licensure information 40, 42:

1. Course information

2. Program and degree information (credits required, costs/tuition rates). This includes and is limited to the following for a selected program of studies:

a. The collection of required courses for the program/licensure program.

b. Required courses.

c. Required courses from specified collection (i.e. 6 credits from following courses, etc.).

d. Related electives and/or concentration courses for the program.

e. Relationship between courses and credit granted for selected ACE or other courses (credit values may be identical or different)

(C) Compendium 44 of selected ACE Courses and courses from other collections for which equivalencies have been entered by registrars or other sources.

(D) Usage Tracking 24, 52, including:

1. Track usage by end users over time. Includes date tracking of a log on, modifications to personal information and modifications to transcript information.

2. Track running of analyzer reports (school, program, license program reports)

3. Track surveys and user reports relating to program effects (individual and group change)

The Interface Requirements for the method and system of the present invention are as follows:

(A) For client interface 10 and developers, access to the research database is via web browser to a SQL Server database maintained by a preferred vendor (i.e. Instructional Materials Depot, Inc., the assignee). The view of information available to researchers is available based on their logging in to a partner college within the system and supplying the assigned PIN. All information is formatted in standard HTML.

(B) For client interface 10, i.e. End-users, access to the production system is through a standard web browser. All information is formatted in standard HTML.

(C) For Server API Interface, the Server-side API may be supported through IIS and COM. Interface to the SQL Server database is through ODBC for all data services.

The Tracking System 24 pulls together data extracts on system utilization from Analyzer/Auditor (School Analysis, Program Analysis, and License Analysis) systems, individual account/transcript systems, and the research system. It supplies counts using WEB TRENDS software to produce tailored reports. In addition, the Tracking System 24 collects data for novel Special Reports to profile:

Program opportunities presented by partner schools

Costs of credit awards for residents, non-residents (savings to reimbursement agencies)

Base costs of programs (by school, based on school tuition rates)

Value of ACE course credit awards (by program and overall)

Value of all credit awards offered by all ACET Auditor partner schools

Ranking of programs by ACET credit value.

In addition to the Utilization and Special Reports, the Tracking System 24 produces Program Evaluation reports which are claimed as novel. These reports focus on results of online survey tools, delivered to users at strategic points in the system. Reports focus on base-line (pre-service) and post-service data collected from online surveys and analyzed using appropriate statistics (including Chi Square) to determine areas of change (effectiveness based on cause-effect of program use) and to measure program effectiveness. These reports are used by program evaluators to review effectiveness and serve as design indicators for continuous program improvement services offered by the inventor.

Annual reports including Utilization reports, Special reports and Program Evaluation reports are provided to ACET partner schools, tuition funding agencies, and holders of ACET Auditor Licenses. Tracking System reports are used for trend analysis within one state, within a region of states, and across regions in the nation.

The principles of this invention having been fully explained in connection with the foregoing, I hereby claim as my invention:

1. A method for auditing academic credit for employment and training of an end user which comprises the steps of
acquiring data regarding the end user's academic credits,
acquiring data regarding the end user's military training and experience, and
providing a data processing system for converting the end user's military training and experience to academic credit,
wherein the end user can compare accumulated credits against a core curriculum at a partner school or licensure program for the purpose of determining what additional credits are required to obtain a degree or license.

2. The method of claim 1 including, prior to said data acquisition steps, the step of creating a database of equivalents, said database of equivalencies including a course program catalog for any number of partner schools and licensure programs participating in the method.

3. The method of claim 1 including, after said database providing step, the step of profiling the user's transcript information against the curriculum requirements of one or more partner schools, programs, or licensure programs.

4. The method of claim 3 including, after said profiling step, the step of providing a school analysis that includes a course profile and cost impact analysis for the user as part of the analysis.

5. The method of claim 3 including, after said profiling step, the step of providing a program analysis that includes a course profile and cost impact analysis for the user as part of the analysis.

6. The method of claim 3 including, after said profiling step, the step of providing a license analysis that includes a course profile and cost impact analysis for the user as part of the analysis.

7. The method of claim 1 wherein the information acquisition steps are performed in real time and made accessible to a user via electronic means.

8. The method of claim 3 including, after said profiling step, the step of generating one or more comparative school, program, or course equivalency reports for the user.

9. The method of claim 8 including, after said report generating step, the step of generating one or more production reports for registrars, researchers, or others for research purposes.

10. The method of claim 8 including, after said user report generating step, the step of providing training to the user for developing and producing a career plan.

11. The method of claim 10 including, after said training providing step, the step of generating a career plan for the user based on productions created during the user's training.

12. The method of claim 8 including, after said user report generating step, the step of providing one or more cognitive training systems for the user via electronic means, including a portfolio development system for development and production of individual equivalency awards.

13. The method of claim 14 including the step of providing a tracking system, said tracking system including means for producing evaluation reports related to the subject method.

14. A system for auditing academic credit for employment and training of an end user which comprises
acquired data regarding the end user's academic credits,
acquired data regarding the end user's military training and experience, and
a data processing system for converting the end user's military training and experience to academic credit,
wherein the end user can compare accumulated credits against a required curriculum at a partner school or licensure program for the purpose of determining what additional credits are required to obtain a specific degree or license.

15. The system of claim 14 including a database of equivalencies, said database including one or more containers for specific data to be entered by any number of partner schools and licensure programs that choose to participate in the system.

16. The system of claim 14 including means for profiling the user's transcript information against the core curriculum of one or more partner schools or licensure programs.

17. The system of claim 16 wherein said profiling means further includes means for providing a school analysis that includes a course profile and cost impact analysis for the user as part of the analysis.

18. The system of claim 16 wherein said profiling means further includes means for providing a program analysis that includes a course profile and cost impact analysis for the user as part of the analysis.

19. The system of claim 16 wherein said profiling means further includes means for providing a license analysis that includes a course profile and cost impact analysis for the user as part of the analysis.

20. The system of claim 14 wherein the information acquisition is performed in real time and made accessible to a user via electronic means.

21. The system of claim 16 including means for generating one or more comparative school, program, or course equivalency reports for the user.

22. The system of claim 16 including means for generating one or more production reports for registrars, researchers, or others for research purposes.

23. The system of claim 16 including means for providing one or more cognitive training systems for the user via electronic means, including a portfolio development system for development and production of individual equivalency awards.

24. The system of claim 16 including means for generating a career plan for the user based on productions created during the user's training.

25. The system of claim 14 including a tracking system, said tracking system including means for producing evaluation reports related to the subject system.
